(19) United States
(12) Patent Application Publication
(10) Pub. No.: US 2017/0268316 A1
(43) Pub. Date: Sep. 21, 2017

(54) CRUDE DRIP CONTAINER

(71) Applicant: Anthony Vega, Bakersfield, CA (US)

(72) Inventor: Anthony Vega, Bakersfield, CA (US)

(21) Appl. No.: 15/465,334

(22) Filed: Mar. 21, 2017

Related U.S. Application Data
(60) Provisional application No. 62/311,209, filed on Mar. 21, 2016.

(51) Int. Cl. E21B 41/00; B65D 21/02; E21B 33/03; F16N 31/00

(52) U.S. Cl. CPC E21B 41/00; F16N 31/006; B65D 21/0204; E21B 33/03

(57) ABSTRACT

The crude oil container has a first container and a second container securely fastened around the exterior of a surface casing of a conventional surface oil well. The crude oil container has a left container and a right container, each having a bottom and walls forming a volume for storage of leaked crude oil. The left and right containers each has a well side with a well receiver surface located between mounting surfaces. The mounting surfaces of the left container are sized to mount flush against the mounting surfaces of the right container. Once so mounted, the surface casing of the oil well is held firmly within the well receiver surface of the left container and the right container such that any crude leaked from the oil well will drip into the left container storage volume and/or right container storage volume of the crude oil container.

### RELATED APPLICATION

This application claims the benefit of priority to the U.S. Provisional Patent Application for “Crude Drip Container,” Ser. No. 62/311,209, filed on Mar. 21, 2016, and currently co-pending.

### FIELD OF THE INVENTION

The present invention pertains generally to a container for the collection and storage of crude oil leaked from wellhead components. More specifically, the present invention pertains to two separate collection pans sized to enclose a wellhead surface casing and collect leaked crude oil. The present invention is particularly, but not exclusively, useful for reducing lost production crude and reducing risk of crude containments near wellhead sites.

### BACKGROUND

Conventional oil and gas extraction often involves the use of a pumpjack located near the wellhead of the oil well. Pumpjacks are easily recognized in oil fields and known by various names such as grasshopper pump, horsehead pump, donkey pumper or oil horse.

In a typical configuration, the pumpjack is connected to a reciprocating piston pump located at the bottom of the well by way of a polishing rod and a string of sucker rods. The polishing rod and connected string of sucker rods moves up and down within the well in order to drive the piston pump, however, only the polishing rod is partially visible at the surface.

A portion of the polishing rod enters and exits the oil well as the pumpjack completes a cycle. This portion of the polishing rod passes through a stuffing box, which acts as a seal between the oil in the oil well and outside environment and keeps the polishing rod lubricated.

As the pumpjack continues through cycles the piston pump draws oil into the well and up to the surface. Once oil and/or gas reaches the surface of the oil well at the wellhead, collected oil and/or gas is directed into an array of horizontal pipes called a Christmas tree, where the collected oil and gas is directed to storage tanks. Each branch of the Christmas tree typically has a one or more valves, a pressure gauge, and connection fittings.

The stuffing box prevents crude oil from leaking at the juncture of the stuffing box and reciprocating polishing rod. However, as an internal gland wears within the stuffing box over time, crude oil begins to leak at the juncture of the stuffing box polishing rod and leaks onto the surface components of the Christmas tree, wellhead and surface casing eventually reaching the surrounding ground. In addition, the various components of the Christmas tree can wear and crude leaks can develop at the Christmas tree valves, pressure gauges and/or connection fittings.

Often pools of crude oil resulting from such leaks can be seen on the ground around the surface casing and wellhead. These pools of crude oil contaminate the surrounding ground and the pool of crude oil becomes waste material as the expense of refining the dirt and debris mixed with the pool exceeds the value of the crude.

There are over 1.1 million active oil and gas wells in the United States alone. As a result, daily monitoring of every active oil well for leaks in the stuffing box or other Christmas tree components is not practical. Similarly, detecting leaks before crude oil reaches the ground and contaminates the same is impractical. As a result, it is common to find pools of wasted crude oil at the base of producing oil wells.

Therefore, there is a need for a device that is inexpensive and robust that can capture and store any crude oil leaked from the stuffing box and other components of the Christmas tree in a producing oil well. There is also a need for a device that allows for the collection of the captured leaked crude in order to maximize production yields.

### SUMMARY OF THE INVENTION

The present invention is directed to a crude drip container that satisfies the need to capture and store crude oil leaked from the stuffing box or other components of the Christmas tree in an oil well. The basic components of the drip crude container are a left container and a right container that fit tightly around the outer diameter surface of the surface casing of the oil well. As leaked crude flows down the Christmas tree and surface casing, the leaked crude collects in the left or right containers of the crude drip container.

The left container has a left container bottom with a left container well side, a left container collection side, a left container front and a left container back collectively forming a left container storage volume. Similarly, the right container has a right container bottom with a right container well side, a right container collection side, a right container front and a right container back collectively forming a right container storage volume.

The left container well side has a left well receiver surface between two left mounting surfaces. The left well receiver surface is curved with a radius slightly larger than the radius of a conventional surface casing of a surface oil well. Similarly, the right container well side has a right well receiver surface between two right mounting surfaces. The right well receiver surface is curved with a radius matching the radius of left well receiver surface.

Both the left container and right container can be equipped with legs connected to the left container bottom and the right container bottom. The legs can be equipped with adjustable feet.

In use, the left container and right container are positioned opposite one another with the surface casing of an oil well located between the left container and the right container. The left container and right container are then moved until the left mounting surfaces of the left container are in contact with the right mounting surfaces of the right container with the perimeter of the surface casing fully encapsulated by the left mounting surface and the right mounting surface. Fasteners secure the left mounting surfaces to the right mounting surfaces such that the surface casing of the oil well is secured between the left well receiver and the right well receiver. Once so secured, crude oil leaked from the components of the oil well (such as the stuffing box or components of the Christmas tree) will be collected by the left casing storage volume and/or the right casing storage volume of the crude drip container. The left container and right container can each be equipped with an optional lid. Each lid has a curved surface that forms an aperture between the curved surface and the left well receiver or the right well receiver allowing crude oil to pass through the aperture into the storage volume of the left container and/or right container. Alternatively, the lids can be formed with a plurality of openings, such as a lattice-style grated cover.

A fluid level equalizer hole is provided in one of the mounting surfaces of both the left container and the right container such that when the left container is connected to the right container, the fluid level equalizer holes are aligned with one another. In use, the fluid level equalizer holes enable crude oil collected from one of the containers to pass through to the other container, thereby ensuring that the full storage capacity of the drip container is available in the event that crude oil only leaks into only either the left container or the right container.

### BRIEF DESCRIPTION OF THE DRAWINGS

The nature, objects, and advantages of the present invention will become more apparent to those skilled in the art after considering the following detailed description in connection with the accompanying drawings, in which like reference numerals designate like parts throughout, and wherein:

FIG. 1 is a side view of a conventional pump jack connected to an oil well via a polishing rod;

FIG. 2 is an isometric detailed view of the oil well shown in FIG. 1 and showing various component parts of Christmas tree laterals, stuffing box and polishing rod;

FIG. 3 is an isometric view of the oil well shown in FIG. 2 and showing an embodiment of the present invention attached to the exterior of the oil well surface casing and having a left container and a right container;

FIG. 4 is a top view of the left container shown in FIG. 3 and showing a left container well side having a curved well receiver surface and mounting surface, a left container collection side having a having on/off valve, a left container front, and a left container rear;

FIG. 5 is a side view of the left container shown in FIG. 3 and showing the left container collection side and left container hydraulic quick connect;

FIG. 6 is a side view of the left container shown in FIG. 3 and showing the left container front;

FIG. 7 is a side view of the left container shown in FIG. 3 and showing the left container well side and mounting through holes;

FIG. 8 is an isometric view of the left side container shown in FIG. 3 and showing the left container storage volume formed by left container bottom, left container well side, left container collection side, left container front and left container rear;

FIG. 9 is a top view of the right container shown in FIG. 3 and showing a right container well side having a curved well receiver surface and mounting surface, a right container collection side having a having on/off valve, a right container front, and a right container rear;

FIG. 10 is a side view of the right container shown in FIG. 3 and showing the right container collection side and right container hydraulic quick connect;

FIG. 11 is a side view of the right container shown in FIG. 3 and showing the right container front;

FIG. 12 is a side view of the right container shown in FIG. 3 and showing the right container well side and mounting through holes;

FIG. 13 is an isometric view of the right side container shown in FIG. 3 and showing the right container storage volume formed by right container bottom, right container well side, right container collection side, right container front and right container rear;

FIG. 14 is a cross sectional view of a surface casing of an oil well and showing an assembly view of the crude drip container around the surface casing of a lateral;

FIG. 15 is a cross sectional view of the surface casing of the oil well shown in FIG. 14 and showing the left container secured to the right container by way of bolts and nuts;

FIG. 16 is the isometric view of the oil well and crude drip container shown in FIG. 3 and showing crude oil leaking from the stuffing box down to the left container and right container where the leaking crude is safely stored until it can be withdrawn using the left container valve and right container valve;

FIG. 17 is a top view of the left container equipped with an optional lid forming an aperture between the curved surface of the lid and the left well receiver surface;

FIG. 18 is a top perspective view of an alternative embodiment of the oil well and crude drip container showing a left container and a right container each with a lattice-style grated cover;

FIG. 19 is a top right perspective view of the oil well and crude drip container shown in FIG. 18;

FIG. 20 is a side view of the left container shown in FIG. 18 and showing the left container front; and

FIG. 21 is a top right perspective view of the oil well and crude drip container with the lattice-style grated cover partially removed to reveal fluid level equalization holes and alternative u-clip styled fasteners connecting the left container to the right container

### DETAILED DESCRIPTION

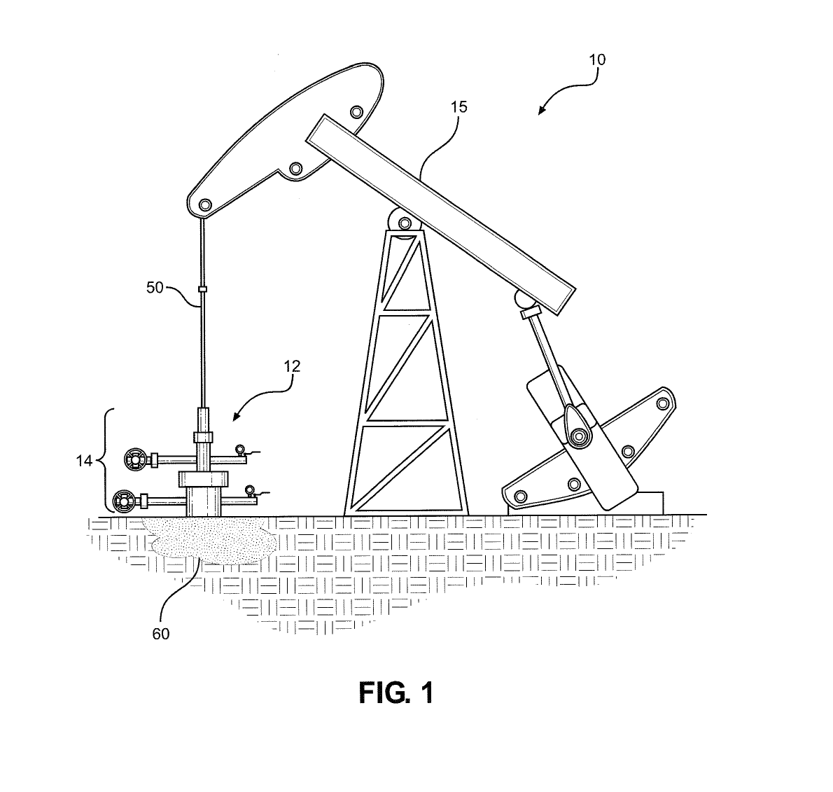

Referring initially to FIG. 1, a typical oil well 10 is shown having a wellhead 12 and a Christmas tree 14 and a pumpjack 15. As set forth more fully below, the Christmas tree 14 is an array of lateral lines directing the collected gas and/or crude oil to a destination, such as an oil transportation pipeline or storage tank. The pumpjack 15 oscillates a polishing rod 50 and a string of sucker rods (not shown) within the oil well 10 to actuate a pump (not shown) near the bottom of the oil well 10 which over time draws crude oil 60 to the surface of the oil well 10 and into the Christmas tree 14 where the crude oil 60 is collected.

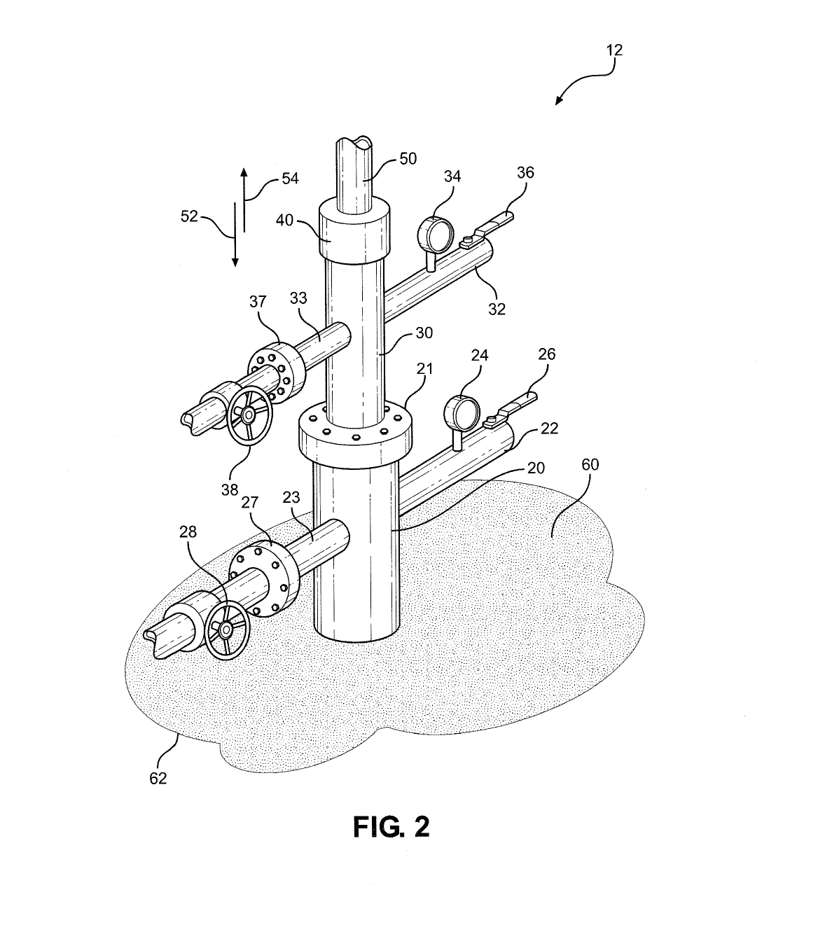

Referring next to FIG. 2, a close up isometric view wellhead 12 and Christmas tree 14 of FIG. 1 is shown with the wellhead 12 having a surface casing 20 partially exposed above the ground. The surface casing 20 terminates above ground in a wellhead flange 21. Extending laterally from the surface casing 20 are surface casing right lateral 22 and surface casing left lateral 23. The surface casing right and left laterals 22 and 23 typically carry gas collected from the oil well 10.

The surface casing right lateral 22 has a surface casing lateral pressure gauge 24 and terminates in a surface casing lateral end valve 26. The surface casing left lateral 23 has a surface casing lateral junction 27 and a surface casing lateral in line valve 28. Gas collected in the oil well 10 passes through the surface casing left lateral 23 to gas collection storage system not shown.

A tubing casing 30 extends down the oil well 10 within the surface casing 20 to a reciprocating piston pump (not shown) near the bottom of the oil well 10. A portion of the tubing casing 30 extends above the surface of the wellhead flange 21 and terminates above ground at stuffing box 40. The tubing casing 30 has a tubing casing left lateral 33 and a tubing casing right lateral 32. The tubing casing right lateral 32 has a tubing casing pressure gauge 34 and terminates in a tubing casing end valve 36. The tubing casing left lateral 33 has a pipe coupling 37 and tubing casing in line valve 38.

As the pumpjack 15 oscillates the polishing rod 50, a portion of the polishing rod 50 passes in the stuffing box 40 during the down-stroke 52 and out of the stuffing box 40 during the up-stroke 54. The stuffing box 40 has an internal gland (not shown) which prohibits crude oil 60 from exiting the stuffing box 40 and spilling onto the surface of the oil well 10 and the ground. The collected crude oil 60 passes into the tubing casing left and right laterals 33 and 32 where the crude oil 60 is ultimately directed to a transportation pipe and storage containers. It is to be appreciated by those skilled in the art that numerous configurations of Christmas trees 14 and wellheads 12 are known in the art.

As the various component parts of the Christmas tree 14 and the gland within the stuffing box 40 wear during prolonged use, leaks of crude oil 60 inevitably develop. The leaked crude oil 60 collects at the ground around the surface casing 20 and forming a crude oil pool 62. The crude oil pool 62 pollutes the surrounding environment and decreases the yield of the oil well 10. In addition, crude oil 60 can also leak when performing routine maintenance on the oil well 10.

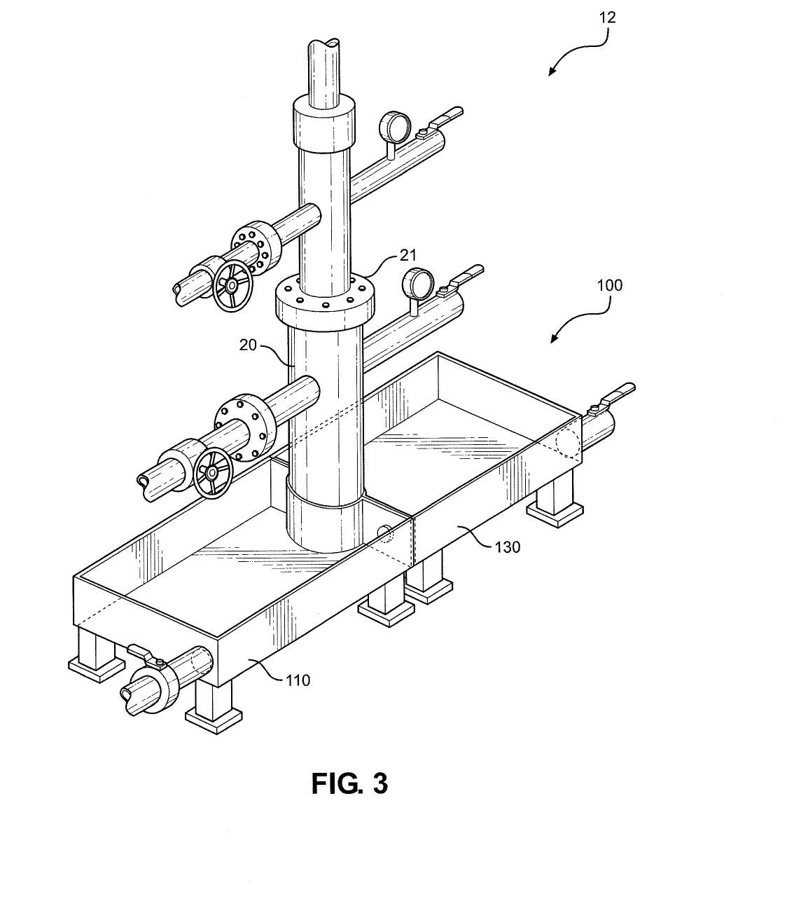

Referring next to FIG. 3, the crude drip container 100 generally comprises a left container 110 and a right container 130. The left container 110 is secured to the right container 130 about the exterior of the surface casing 20 using fasteners.

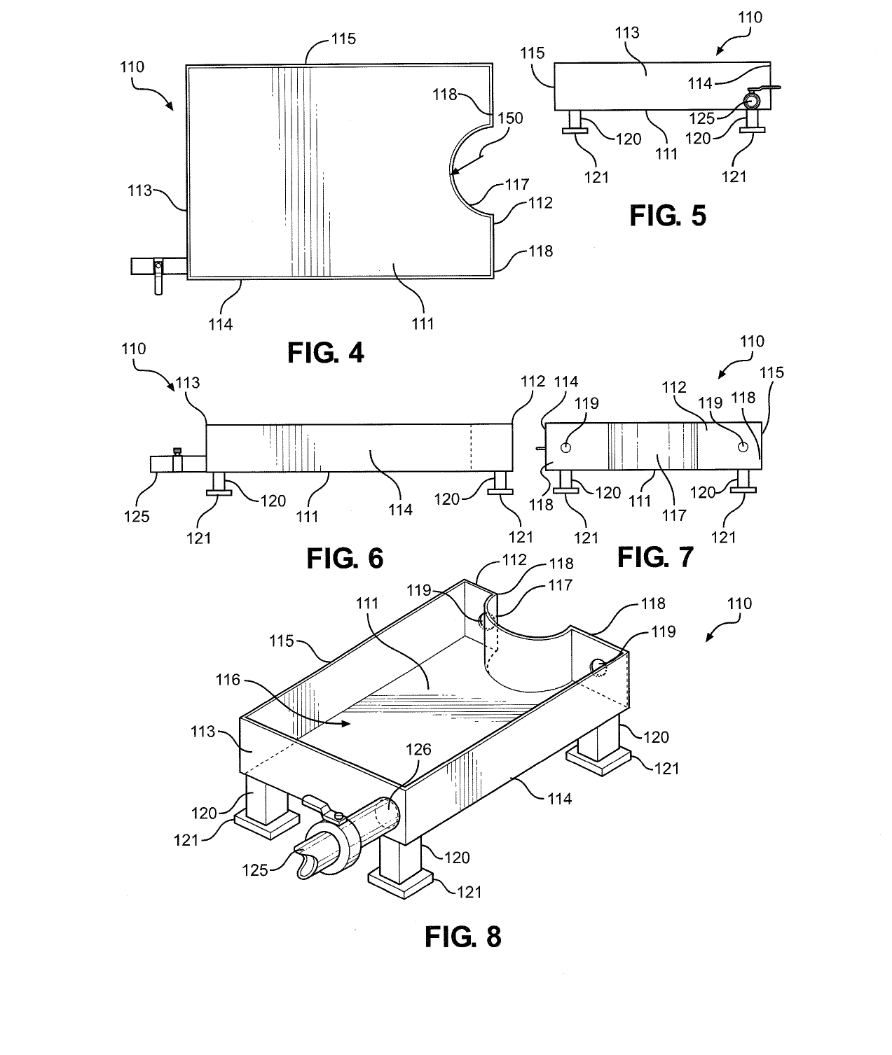

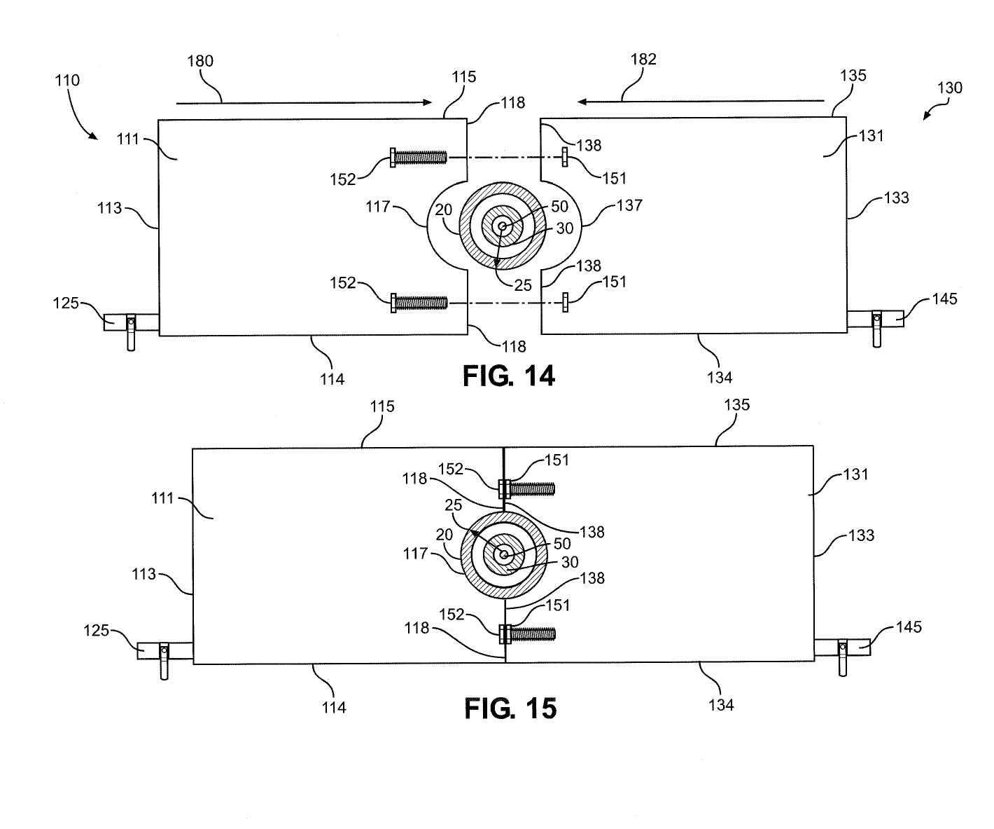

Referring next to FIGS. 4 through 8, the left container 110 has a left container bottom 111, a left container well side 112, a left container collection side 113, a left container front 114 and a left container back 115. The left container well side 112, left container collection side 113, left container front 114 and left container back 115 are each connected to left container bottom 111 forming a left container storage volume 116. The left container well side 112 has a left well receiver surface 117 between two left mounting surfaces 118. The left well receiver surface 117 is curved with left wellhead receiver radius 150. The left wellhead receiver radius 150 is slightly larger than the surface casing radius 25 (shown in FIG. 14 below) such that the left well receiver surface 117 can fit flush against the exterior of the surface casing 20 of oil well 10. Each of the left mounting surfaces 118 has a fastener hole 119 to accommodate a fastener.

Legs 120 are attached to the left container bottom 111 opposite the left container storage volume 116. Feet 121 are attached to legs 120 in order to increase the stability of the left container 110 when the feet 121 are in contact with the ground. It is to be appreciated by those skilled in the art that feet 121 can be made to be adjustable with respect to legs 120 such that the left container 110 can remain level even if uneven ground is encountered near the oil well 10.

A left container valve 125 is connected to the left container collection side 113 at left container collection port 126. The left container collection port 126 is an opening through the left container collection side 113 near the left container bottom 111. The left container valve 125 can be made of any valve known in the art. In one embodiment, the left container valve 125 is a ball valve with a hydraulic quick connect.

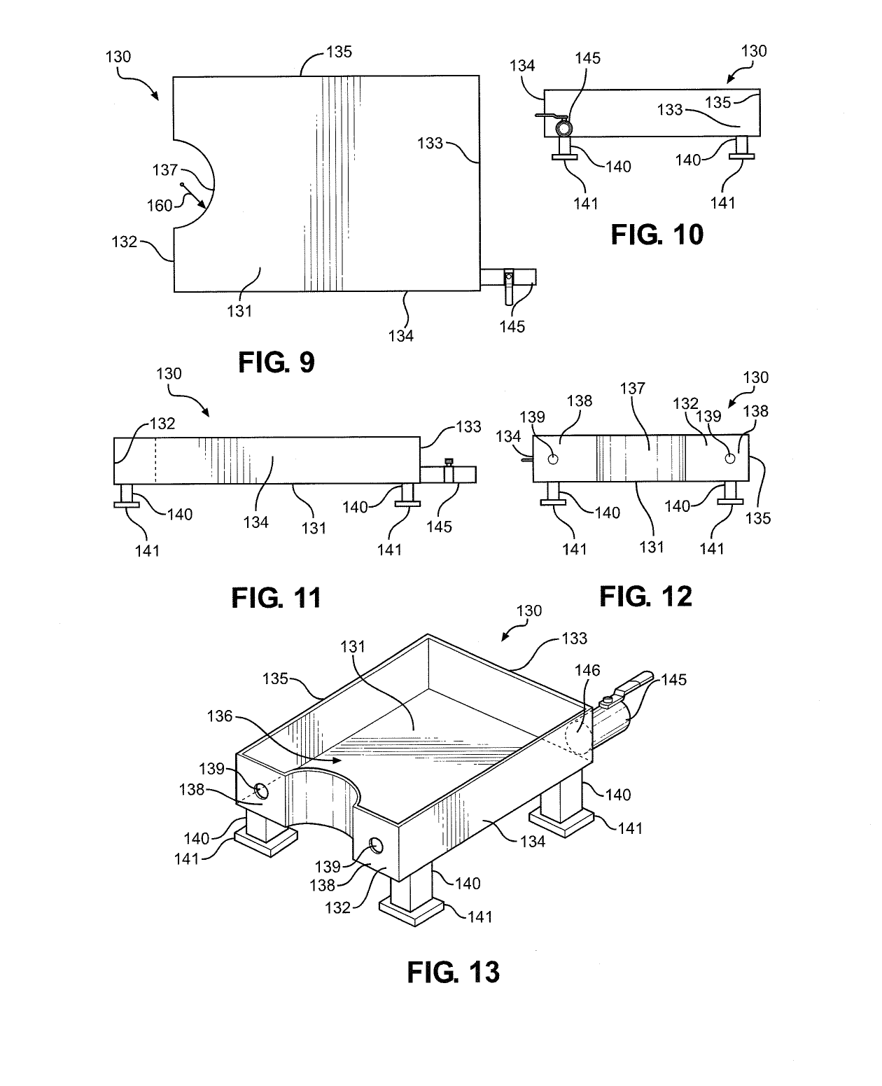

Referring next to FIGS. 9 through 13, the right container 130 has a right container bottom 131, a right container well side 132, a right container collection side 133, a right container front 134 and a right container back 135. The right container well side 132, right container collection side 133, right container front 134 and right container back 135 are each connected to right container bottom 131 forming a right container storage volume 136. The right container well side 132 has a right well receiver surface 137 between two right mounting surfaces 138. The right well receiver surface 137 is curved with a right wellhead receiver radius 160. The right wellhead receiver radius 160 is slightly larger than the surface casing radius 25 (shown in FIGS. 14 and 15 below) such that the right well receiver surface 137 can fit flush against the exterior of the surface casing 20 of oil well 10. Each of the right mounting surfaces 138 has a fastener hole 139 to accommodate a fastener.

Right container legs 140 are attached to the right container bottom 131 opposite the right container storage volume 136. Right container feet 141 are attached to right container legs 140 in order to increase the stability of the right container 130 when the right container feet 141 are in contact with the ground. It is to be appreciated by those skilled in the art that right container feet 141 can be made to be adjustable with respect to right container legs 140 such that the right container 130 can remain level even if uneven ground is encountered near the oil well 10.

A right container valve 145 is connected to the right container collection side 133 at right container collection port 146. The right container collection port 146 is an opening through the right container collection side 133 near the right container bottom 131. The right container valve 145 can be made of any valve known in the art. In one embodiment, the right container valve 145 is a ball valve with a hydraulic quick connect.

The left and right containers can be made of any material known in the art. In one embodiment, the left and right containers are made of polymer. In another embodiment, the left and right containers are made of aluminum. The left container 110 and right container 130 can be many different shapes or sizes provided each has respective left and right well receiver surfaces 117 and 137.

Referring next to FIGS. 14 and 15, the procedure to install the crude oil container 110 around the surface casing 20 of an oil well 10 is generally shown. First, left container 110 and right container 130 are placed opposite one another with the surface casing 20 of an oil well 10 between the left container 110 and the right container 130. The left container well side 112 of the left container 110 and the right container well side 132 of the right container 130 are each positioned facing opposite ends of the surface casing 20. The left container 110 is moved in direction 180 and the right container 130 is moved in opposite direction 182 until the well receiver surface 117 is in contact with the surface casing 20 and the right well receiver surface 137 is in contact with the surface casing 20. As noted previously, the wellhead receiver surfaces 117 and 137 are sized to fit snugly around the surface casing 20 having a casing radius 25. Fasteners then secure the left container 110 and the right container 130 to the surface casing 20. In an embodiment, the fasters include a bolt 152 passed through each left fastener hole 119 and each right fastener hole 139 and a nut 151. The bolt 152 and nut 151 then ensure that the left mounting surface 118 is securely held against the right mounting surface 138 and that left well receiver surface 117 and right well receiver surface are also held securely against the surface of the surface casing 20. Once so secured, the crude drip container 100 is ready to collect any crude oil 60 and prohibit such crude oil 60 that leaks from failing well components.

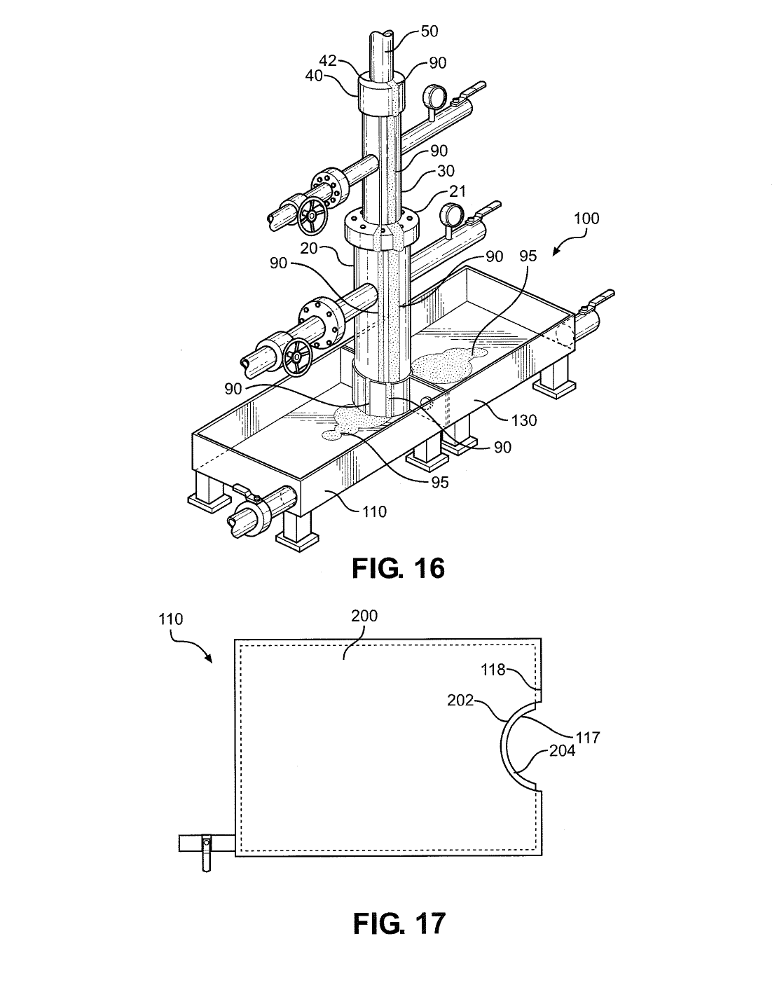

Referring next to FIG. 16, the crude drip container 100 is shown installed around a surface casing 20 of an oil well 10 that has developed an oil leak 90 at the junction 42 of stuffing box 40 and the polishing rod 50. The oil leak 90 runs down the tubing casing 30, the wellhead 12, and the surface casing 20 until it reaches the left container 110 and right container 130. The oil leak 90 runs down the left container collection side 112 and the right container collection side 132 where is forms collected oil pools 95 within the left container storage volume 116 and right container storage volume 136. As the oil leak 90 continues, the left container storage volume 116 and right container storage volume 136 slowly fill with oil pools 95. When the left container 110 and right container 130 are nearly at capacity, a field hand simply connects a hose to the left container valve 125 and right container valve 145, open the valves, and drain the oil pools 95 into a storage tank, or oil transportation truck.

Referring next to FIG. 17, the left container 110 is shown with optional lid 200. The lid 200 has a curved surface 202 with a larger radius than radius 150 of the left well receiver surface 117 thereby creating an oil aperture 204 between the left well receiver surface 117 and curved surface 202. Oil leak 60 can pass from the surface casing 20 through the oil aperture 204 and into the left container storage volume 116 of the left container 110. The lid 200 helps to keep dirt and other debris from entering and contaminating oil pools 95 stored within the left container storage volume 116. Although not shown in FIG. 17, an identically configured lid is contemplated for use in connection with right container 130.

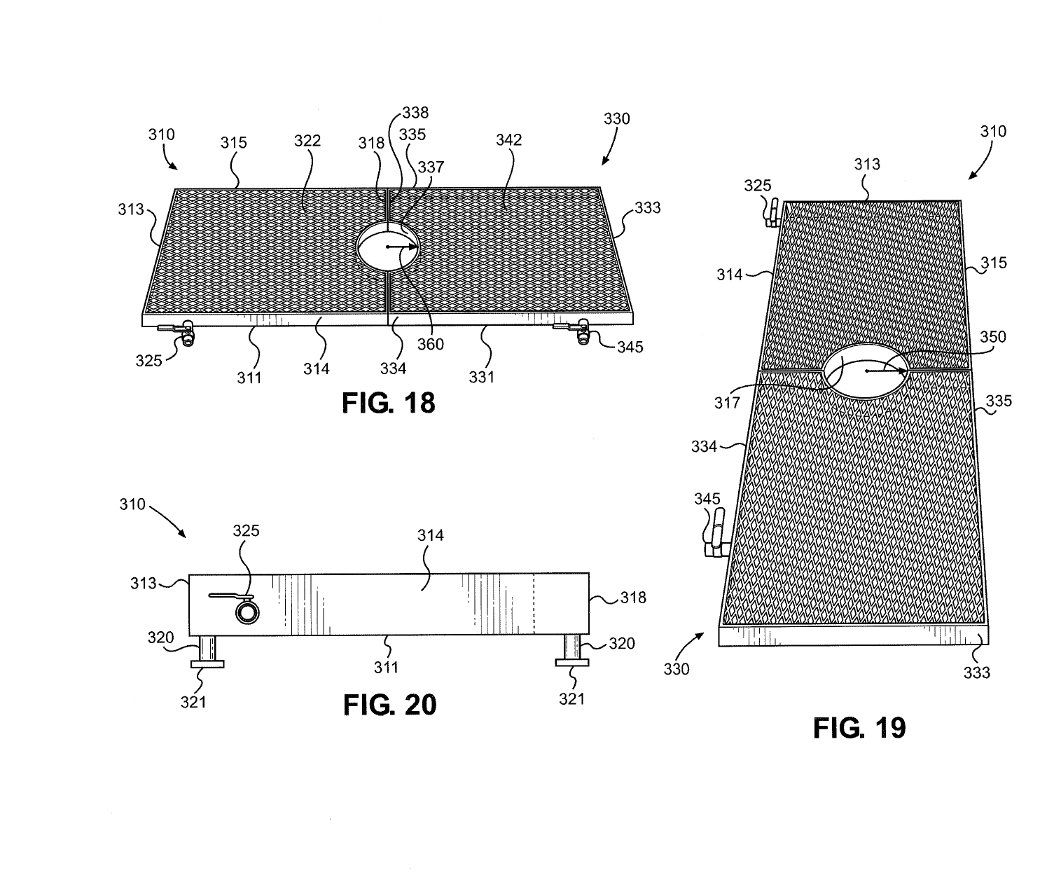

Referring next to FIGS. 18 and 19, a alternative embodiment of a crude drip container is shown with a left container 310 having a left container lattice-style grated cover 322 and a right container 330 having a right container lattice-style grated cover 342. As in other embodiments, the left container 310 has a left container bottom 311, a left container well side 318 with two mounting surfaces, a left container collection side 313, a left container front 314, and a left container back 315, connected to provide a storage volume for collected crude oil. The left container well side 318 has a left well receiver surface 317 between the two mounting surfaces. The left well receiver surface 317 is curved with left wellhead receiver radius 350, sized to allow the left container 310 to fit flush against the exterior of the surface casing 20 of oil well 10. The left and right lattice-style grated covers 322 and 344 have a plurality of openings sized to allow leaked crude oil to pass through one or more of the plurality of openings into the left and right container storage volumes. The use of a lattice-style to create the plurality of openings is by no means meant to be limiting. Other styled openings, such as slots, ovals, circles, etc are meant to be embraced by this specification. The plurality of openings must be sized large enough to enable the free flow of high viscosity crude oil into and through the openings while also sized small enough to protect the collected crude oil from other contaminates, such as tumble weeds, garbage, animals, dropped tools, etc.

A left container valve 325 is connected to the left container collection side 313 at a left container collection port (not shown). As in other embodiments, the left container collection port is an opening through left container collection side 313 near the left container bottom 311. The left container valve 325 can be made of any valve known in the art, and in particular may be a ball valve with a hydraulic quick connect.

Similarly, the right container 330 has a right container bottom 331, a right container well side 338 with two mounting surfaces, a right container collection side 333, a right container front 334, and a right container back 335, connected to provide a storage volume for collected crude oil. The right container well side 338 has a right well receiver surface 337 between the two mounting surfaces. The right well receiver surface 337 is curved with right wellhead receiver radius 360, sized to allow the right container 330 to fit flush against the exterior of the surface casing 20 of oil well 10. In general, this means that the right wellhead receiver radius 360 is the same as the left wellhead receiver radius 350.

A right container valve 345 is connected to the right container collection side 333 at a right container collection port (not shown). As in other embodiments, the right container collection port is an opening through right container collection side 333 near the right container bottom 331. The right container valve 345 can be made of any valve known in the art, and in particular may be a ball valve with a hydraulic quick connect.

Referring now to FIG. 20, a side view of left container 310 is shown, with the left container front 314 being displayed. From this view it can be seen that legs 320 are attached to the left container bottom 311, and feet 321 are attached to legs 320 in order to increase the stability of the left container 310 when the feet 321 are in contact with the ground. The feet 321 can be made adjustable with respect to the legs 320 such that the left container 310 can remain level even if uneven ground is encountered near the oil well. In one embodiment, four feet 321 are used, one foot proximate each corner formed by the connections between left container front 311, the left container collection side 313, the left container back 315, and the left container well side 318. It is contemplated that the right container 330 also includes legs and feet (not shown) in a manner similar to the left container 310.

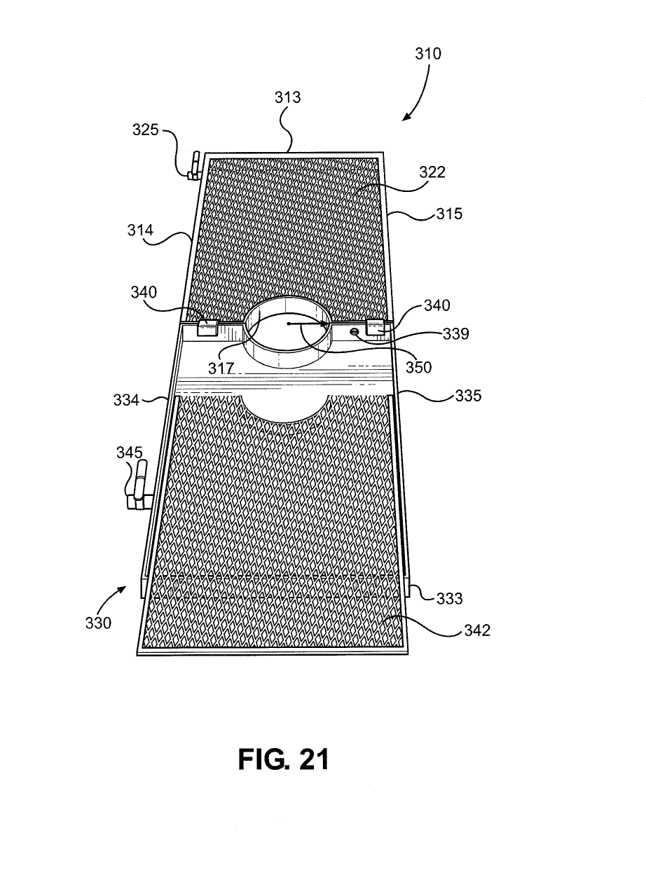

Referring next to FIG. 21, a crude drip container 310 is shown with the right container lattice-style grated cover 342 partially removed to reveal a fluid level equalizer hole 339 in both the right and left containers 330 and 310. The fluid level equalizer hole 339 is located in the middle of one of the mounting surfaces on the right container well side 338. Similarly, a corresponding fluid level equalizer hole 339 is located in the middle of one of the mounting surfaces on the left container well side 318. The two fluid level equalizer holes 339 are positioned to ensure they align with one another when the left container 310 is connected to the right container 330. Once so connected, the fluid level equalizers allow crude oil collected in the left container 310 to pass through the fluid level equalizers 339 to the right container 330. As configured, should crude oil leak into only the left or right container, the storage capacity of both the left container 310 and the right container 330 will be available to collect the leaked crude oil.

In FIG. 21 an alternative fasteners are shown securing the left container 310 to the right container 330. More specifically, U-shaped mounting clips 340 are fastened over each of the two mounting surface sides 338 and 318. Thus ensuring that the left mounting surface 318 is securely held against the right mounting surface 338 and that left well receiver surface 317 and right well receiver surface 337 are also held securely against the surface of the surface casing. While there have been shown what are presently considered to be preferred embodiments of the present invention, it will be apparent to those skilled in the art that various changes and modifications can be made herein without departing from the scope and spirit of the invention.

What is claimed is:

1. A crude drip container comprising:
a left container having a left container storage volume wherein the left container is configured with a left well receiver surface;
a right container having a right container storage volume wherein the right container is configured with a right container well receiver surface;
wherein the left well receiver surface and the right well receiver surface are each configured to fit flush against an exterior surface casing of an oil well such that leaked crude oil from the oil well is collected in the left container storage volume of the left container and or the right container storage volume of the right container; and
a means for securing the left container to the right container such that the surface casing of the oil well is disposed between the left container and the right container.

2. The crude drip container of claim 1 wherein the left container further comprises a left container front, a left container back, a left container side, a left container well side, and a left container bottom, each connected to together to form the left container storage volume and wherein the right container further comprises a right container front, a right container back, a right container side, a right container well side, and a right container bottom, each connected to together to form the right container storage volume.

3. The crude drip container of claim 2 wherein the left container well side has a left arc-shaped indentation formed with a left container radius and the right container well side has a right arc-shaped indentation formed with a right container radius.

4. The crude drip container of claim 3 wherein both the left container radius and the right container radius are less than a surface casing radius of the surface casing.

5. The crude drip container of claim 1 wherein a left container valve is connected to the left container and configured to enable the quick removal of the leaked crude collected by the left container and wherein a right container valve is connected to the right container and configured to enable to the quick removal of the leaked crude collected by the right container.

6. The crude drip container of claim 1 wherein the left container has a left container lid and the right container has a right container lid wherein the left container lid and the right container lid are each configured with an aperture sized to allow the leaked crude to pass into the left container volume and/or the right container volume through the apertures.

7. The crude drip container of claim 1 wherein the left container has a left container lid and the right container has a right container lid wherein the left container lid and the right container lid are formed with a plurality of openings sized to collect the leaked crude through the plurality of openings while isolating the leaked crude collected in the crude drip container from other contaminants.

8. The crude drip container of claim 1 wherein the left container and the right container are each formed with adjustable feet.

9. A crude drip container comprising:
a left container having a left container front, a left container back, a left container side, a left container well side, and a left container bottom, each connected to together to form a left container storage volume wherein the left container well side has a left well receiver surface disposed between a first left mounting surface and a second left mounting surface;
a right container having a right container front, a right container back, a right container side, a right container well side, and a right container bottom, each connected to together to form a right container storage volume wherein the right container well side has a right well receiver surface disposed between a first right mounting surface and a second right mounting surface;
wherein the left well receiver surface and the right well receiver surface are each configured to fit flush against an exterior surface casing of an oil well such that leaked crude oil from the oil well is collected in the left container storage volume of the left container and or the right container storage volume of the right container; and
wherein the first left mounting surface is connected to the first right mounting surface and the second left mounting surface is connected to the second right mounting surface such that a left fluid level equalizer hole provided in the first left mounting surface is aligned with a right fluid level equalizer hole provided in the first right mounting surface.

10. The crude drip container of claim 9 further comprising adjustable feet connected to the left container bottom and to the right container bottom such that the left container and the right container can each be maintained in a level position.

11. The crude drip container of claim 10 wherein a left container valve is connected to the left container and configured to enable the quick removal of the leaked crude collected by the left container and wherein a right container valve is connected to the right container and configured to enable to the quick removal of the leaked crude collected by the right container.

12. The crude drip container of claim 11 wherein the left container has a left container lid and the right container has a right container lid wherein the left container lid and the right container lid are each configured with an aperture sized to allow the leaked crude to pass into the left container volume and or the right container volume through the apertures.

13. The crude drip container of claim 11 wherein the left container has a left container lid and the right container has a right container lid wherein the left container lid and the right container lid are formed with a plurality of openings sized to collect the leaked crude through the plurality of openings while isolating the leaked crude collected in the crude drip container from other contaminants.

14. The crude drip container of claim 11 wherein the left container valve and the right container valve are each a ball valve equipped with a hydraulic quick connect fitting.

15. The crude drip container of claim 11 wherein the left container and right container are connected together by fasteners.

16. A method of capturing and collecting leaked crude oil at a wellhead comprising the steps of:
(a) Providing a crude drip container comprising:
a left container having a left container storage volume wherein the left container is configured with a left well receiver surface;
a right container having a right container storage volume wherein the right container is configured with a right container well receiver surface;
wherein the left well receiver surface and the right well receiver surface are each configured to fit flush against an exterior surface casing of an oil well such that leaked crude oil from the oil well is collected in the left container storage volume of the left container and or the right container storage volume of the right container;
a means for securing the left container to the right container such that the surface casing of the oil well is disposed between the left container and the right container and
a means for retrieving the leaked crude oil collected in the left container and the right container;
(b) Allowing sufficient time for the leaked crude oil to collect in the left container and or the right container;
(c) Retrieving the leaked crude oil collected in the left container and the right container by using the means for retrieving the leaked crude oil.

17. The method of capturing and collecting leaked crude oil at a wellhead of claim 16, wherein the means for retrieving the leaked crude oil includes equipping the left container with a left valve in fluid communication with the leaked crude oil collected in the left container and a right valve in fluid communication with the leaked crude oil collected in the right container.

18. The method of capturing and collecting leaked crude oil at a wellhead of claim 17 wherein step (c) further comprises connecting a hose to the left valve, opening the left valve, and draining the leaked crude oil collected in the left container to a transportation receptacle.

19. The method of capturing and collecting leaked crude oil at a wellhead of claim 18 wherein step (c) further comprises connecting a hose to the right valve, opening the right valve, and draining the leaked crude oil collected in the right container to a transportation receptacle.

20. The method of claim 18 wherein the transportation receptacle is an oil transportation truck.
